(19) United States
(12) Patent Application Publication
(10) Pub. No.: US 2016/0141780 A1
(43) Pub. Date: May 19, 2016

(54) MEANS FOR MOUNTING A CONNECTOR

(71) Applicant: Nicholas ARCHDALE, Austin, TX (US)

(72) Inventor: Nicholas ARCHDALE, Austin, TX (US)

(21) Appl. No.: 14/406,511

(22) PCT Filed: Jun. 8, 2013
(86) PCT No.: PCT/US13/44858

§ 371 Date: Dec. 8, 2014

Related U.S. Application Data
(60) Provisional application No. 61/657,448, filed on Jun. 8, 2012.

(51) Int. Cl. H01R 12/70

(52) U.S. Cl. CPC H01R 12/7076

(57) ABSTRACT

Described is an improved DVI connector system for connecting DVI data cables to electronic circuit boards.

### RELATED APPLICATION

This application claims priority of United States provisional application with the same title Ser. No. 61/657,448 filed on 8 Jun. 2012.

### TECHNICAL FIELD OF THE INVENTION

The present invention generally relates to means for mounting a connector on a circuit board, specifically to the use of an intermediate system to facilitate simple replacement of the connector.

### BACKGROUND OF THE INVENTION

It is well known to use a DVI (Digital Video Interface) connector for connecting a video source to a video display, or for otherwise communicating digital video signals from one component of a video system to another. The DVI connector was developed in 1999 by the Digital Display Working Group, a consortium of manufacturers including Intel, Hewlett-Packard and others, to provide a standardized connector for transmitting digital video signals. Various models of this family of connectors support digital signals or analog signals alone, as well as versions that support both simultaneously. Although originally designed for computer devices such as monitors, usage of the DVI connector has spread to a broader range of both consumer and professional video equipment. Many different manufacturers now produce their versions of the DVI connector, however they all remain true to the original standard and are both mechanically and electrically interchangeable and inter-connectable.

One problem with the increase in use of the DVI connector is that it is now being used in situations which require robust usage where, for example, it is desirable to be able to connect and disconnect the DVI connector many times. One example might be a touring theatrical production or traveling product demonstration where it is desirable to be able to connect and disconnect the video displays from the video source equipment on a daily basis. Or they may be used in a studio where video monitors are being re-sited on set repeatedly throughout the day.

The original DVI specification was designed for applications where such connection and disconnection was infrequent, and thus these connectors only have a 500 insertion lifetime. The result is the connectors are subject to frequent failure in the scenarios described. This is not too much of a problem for the cable-mounted end of a connector pair, as it is simple to replace that cable, however it can be a significant problem to replace a DVI connector that is mounted to a circuit board. Such mounting configurations are designed to be permanent since they are typically soldered in place. It is difficult to unsolder and replace these units, often putting a piece of equipment out of service for considerable lengths of time while connectors are replaced.

FIG. 3 shows an example of the prior art mounting of such a connector on a circuit board. DVI connector 52 is mounted on circuit board 60 through pins 18 which pass through circuit board 60 and are individually soldered in position. Removing and replacing this connector requires de-soldering each of the pins 18, removing the connector, cleaning and repairing the circuit board 60, and finally positioning and soldering a new connector in place. A time consuming task that also weakens and potentially damages the circuit board.

It would be advantageous to be able to replace a DVI connector that is mounted to a circuit board in a manner that is simple, quick, and that decreases the risk of damage to the circuit board.

### BRIEF DESCRIPTION OF THE DRAWINGS

For a more complete understanding of the present invention and the advantages thereof, reference is now made to the following description taken in conjunction with the accompanying drawings in which like reference numerals indicate like features and wherein:

FIG. 1 illustrates a top view of an embodiment of the invention installed on a circuit board;

FIG. 2 illustrates a top view of an embodiment of the invention disconnected from the circuit board;

FIG. 3 illustrates a prior art means for mounting a DVI connector on a circuit board;

FIG. 4 illustrates an isometric view of an embodiment of the invention mounted in place on a circuit board;

FIG. 5 illustrates an isometric view of an embodiment of the invention unplugged from the circuit board;

FIG. 6 illustrates a isometric view of a partially disassembled embodiment of the invention; and,

FIG. 7 illustrates an isometric view of an embodiment of the invention in a panel.

### DETAILED DESCRIPTION OF THE INVENTION

Preferred embodiments of the present invention are illustrated in the FIGUREs, like numerals being used to refer to like and corresponding parts of the various drawings.

The present invention generally relates to means for mounting a connector on a circuit board, specifically to the use of an intermediate system to facilitate simple replacement of the connector.

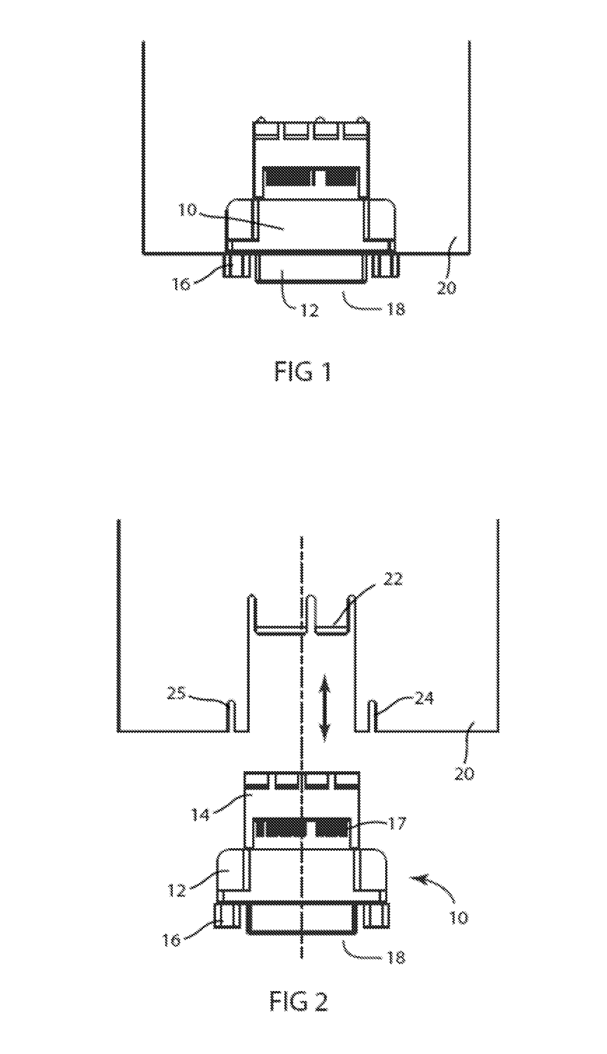

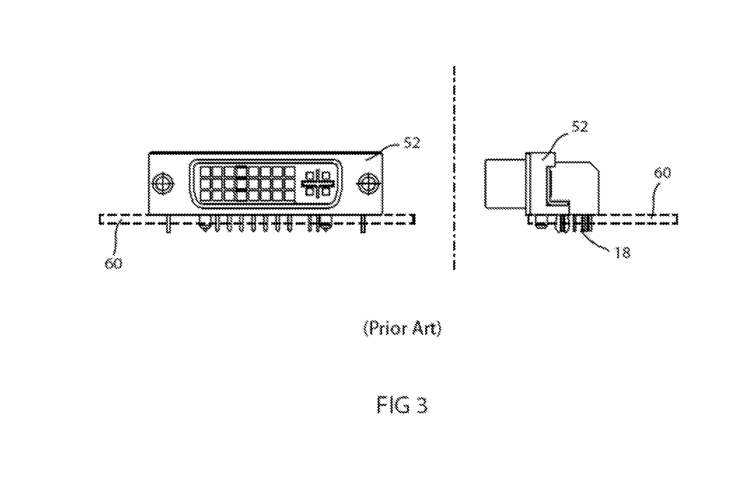

FIG. 1 illustrates a top view of an embodiment of the invention. DVI caddy 10 is mounted on a circuit board 20. The DVI caddy 10 includes conventional DVI connector sockets 18 and threaded connectors 16 for receiving conventional DVI cable connectors (not shown).

FIG. 2 illustrates a top view of the caddy 10 dismounted from the circuit board 20. In the embodiment shown, the DVI caddy incorporates a DVI connector 12 with an edge connector 14. The DVI connector can be a conventional connector such as the Molex 74320-1003. The edge connector 14 may be a standard PCIe edge connector such as the Tyco 1-1734857-1 or Sullins NWE18DHRN-T94x0. Edge connector 14 connects via an array of electronic connector pins/pads 17 with a matching/mating array of circuit board contacts 22 providing electrical connection for all signals to circuit board 20. Note the actual circuit board electrical contacts pins/pads (not shown) are on the underside of circuit board contacts 22 as illustrated in FIG. 2.

There may further be notches or other mechanisms to assist with mechanical connection and alignment such as notches 24 and 25. To replace DVI connector 12 when it fails, the entire DVI caddy 10 may be simply unmounted/unplugged from circuit board 20 and a replacement DVI caddy mounted/plugged back into place on the circuit board 20. This operation is very simple and quick, requires no soldering, and few (if any) tools, and can happen in-situ without having to send the piece of video equipment back to a repair shop.

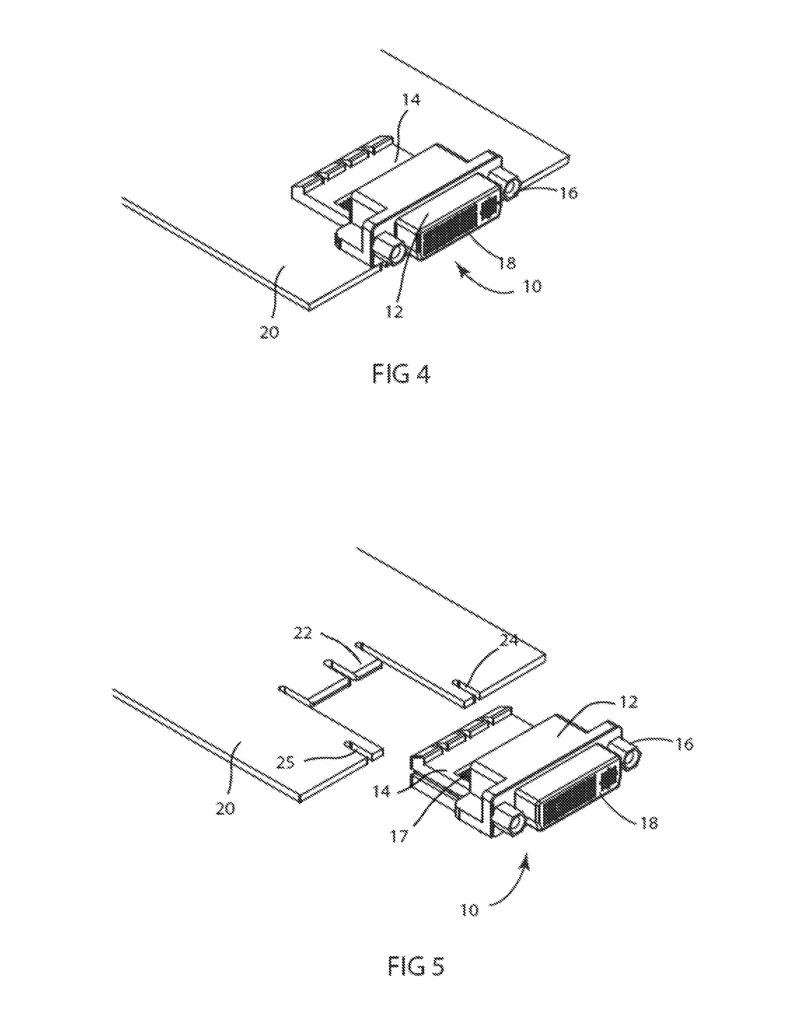

FIGS. 4 illustrates an isometric view of the DVI caddy 10 mounted in place on circuit board 20.

FIG. 5 illustrates an isometric view of the DVI caddy 10 dismounted/unplugged from circuit board 20.

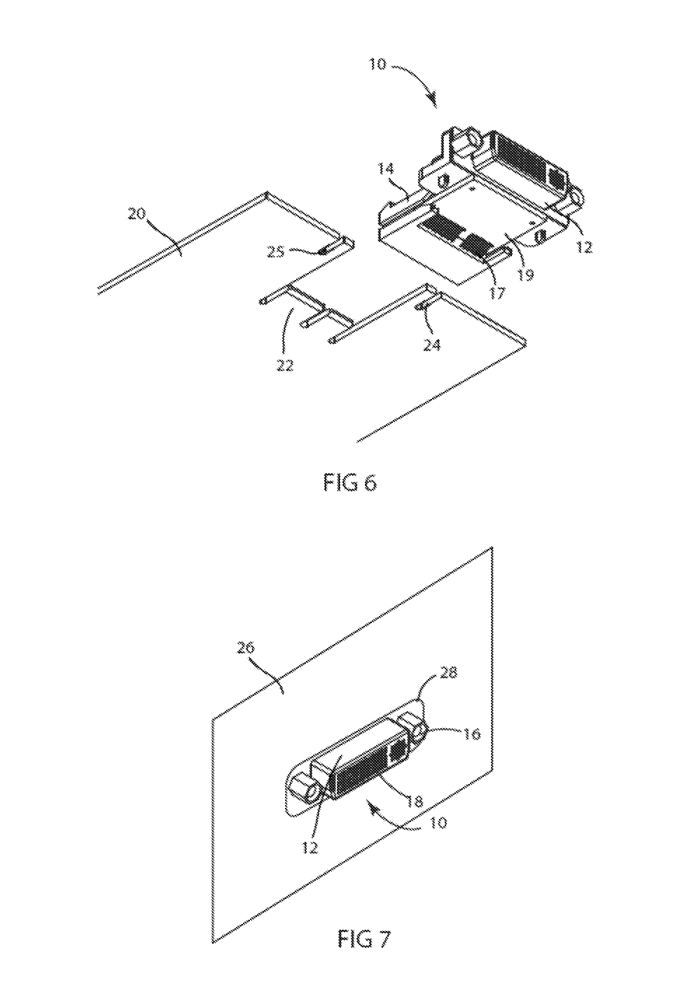

FIG. 6 illustrates an alternative isometric view of the embodiment of the DVI caddy 10 illustrated in FIG. 5 dismounted from the circuit board 20 and partially disassembled. In the embodiment shown, the DVI connector 12 may be mounted on small linking circuit board 19 which provides both mechanical support for DVI connector 12 and provides electrical connections from the pins (not shown) of DVI connector 12 to the pins/pads 17 of edge connector 14. In the illustrated embodiment DVI connector 12 uses through-hole pins (not shown), and PCIe connector 14 use surface-mount pins/pads 17, however the invention is not so limited and surface-mount, through-hole or other connection types as well known in the art may be utilized.

FIG. 7 illustrates an isometric view of an embodiment of the invention mounted on a circuit board (not shown) which mounted in a panel 26. DVI connector 12 is mounted such that it protrudes through aperture 28 in panel 26. Panel 26 retains the sides of connector 12 and thus serves to retain the caddy and to prevent it from becoming unplugged from the circuit board. Other means as well known in the art may also be used to retain the caddy without departing from the spirit of the invention.

With the system of the invention the insertion life of the system before a circuit board must be repaired, is now the product of the insertion life of the DVI connector 12 and edge connector 14. For example, if DVI connector 12 is rated for 500 insertions, and edge connector 14 is rated for 50 insertions, then the caddy system described is now rated for 50×500=25,000 insertions before circuit board 22 may have to be repaired. This is a sufficient life time for the projected usage of this component, and allows for the scenarios in touring theatre, or TV studio use described above.

A further advantage of the disclosed invention is that it does not occupy any more back panel or circuit board space than the original connector. Thus DVI connectors may be stacked as closely as before while gaining the advantage of becoming easily replaceable. This offers the user and manufacturer significant advantages when producing a card cage based product or other compact product. A yet further advantage of the disclosed invention is that the panel mounting of the DVI connector remains unaltered. The invention may therefore be retrofitted to existing products by modifying just the circuit board layout. No extra mechanical or mounting components are needed and no changes need be made to existing panels.

Although this disclosure has discussed the invention as an improvement for the mounting of a DVI connector, the invention is not so limited and may be utilized with other similar connectors. For example HDMI, DisplayPort, and Mini DisplayPort connectors suffer from the same limited insertion lifetime problems as the DVI connector and further embodiments of the invention may provide replaceable caddy solutions for those connectors using the same technique. In yet further embodiments of the invention the disclosed caddy solution may be used with any connector where it is desirable to make the connector easily replaceable on a circuit board without the need for de-soldering and soldering in a replacement.

While the disclosure has been described with respect to a limited number of embodiments, those skilled in the art, having benefit of this disclosure, will appreciate that other embodiments may be devised which do not depart from the scope of the disclosure as disclosed herein. The disclosure has been described in detail, it should be understood that various changes, substitutions and alterations can be made hereto without departing from the spirit and scope of the disclosure.

What is claimed is:

1. A DVI connector, for receiving DVI cable connectors, which is mechanically connected to a second connector which is removably electrically connectable to a circuit board, whereby the DVI cable connector and second connector can easily be removed as a unit and replaced with another DVI cable second connector unit.

2. A DVI connector of claim 1 where the second connector is removably, mechanically connected to the circuit board.

3. The DVI connector of claim 1 where the mechanical connection to the second connector is also the electrical connection to the second connector.

4. The DVI connector of claim 2 where the mechanical connection mechanism of the second connector to the circuit board also aligns the electrical connection between the second connector and the circuit board.
